(19) United States
(12) Patent Application Publication
(10) Pub. No.: US 2023/0137293 A1
(43) Pub. Date: May 4, 2023

(54) PROTECTION CIRCUIT FOR PROTECTING A BATTERY

(71) Applicant: ASSA ABLOY AB, Stockholm (SE)

(72) Inventors: Olle BLIDING, Halmstad (SE); Eric WIEBOLS, Halmstad (SE)

(21) Appl. No.: 17/910,631

(22) PCT Filed: Mar. 12, 2021
(86) PCT No.: PCT/EP2021/056357

§ 371 Date: Sep. 9, 2022

(30) Foreign Application Priority Data
Mar. 13, 2020 (SE) 2050273-8

(51) Int. Cl. H02J 7/00; H01M 10/44

(52) U.S. Cl. CPC H02J 7/0031; H01M 10/441; H02J 7/0063; H02J 7/00306; H02J 7/007182; H02J 7/007188

(57) ABSTRACT

It is provided a protection circuit for protecting a battery comprising a plurality of lithium primary cells. The protection circuit comprises: a switch configured to control when the battery supplies power to a load; and a control circuit being configured to: detect, at a first point in time, when a voltage across at least part of the battery falls below a threshold voltage; and open the switch when the voltage across at least part of the battery is remains below the threshold voltage during a preconfigured duration from the first point in time, wherein the opening of the switch is irreversible.

### TECHNICAL FIELD

The present disclosure relates to the field of batteries, such as lithium batteries, and in particular to a protection circuit for protecting a battery comprising a plurality of lithium primary cells.

### BACKGROUND

Lithium batteries are increasing in use due to excellent energy density. Secondary cell (i.e. rechargeable) lithium batteries are common in a plethora of different types of electronic devices, e.g. smartphones, computers and even vehicles.

Increasingly, primary cell lithium batteries are used in certain applications, for instance when the user should be prevented from handling batteries, such as in certain electronic locks.

However, lithium batteries are sensitive devices. If the cell voltage of a lithium battery falls below a critical voltage due to malfunction, the cell can be damaged and expand or even explode, which can cause damage to equipment, property and people.

When lithium cells are not used for a certain period of time, a chemical layer forms on an exterior surface of the cell. When power is again supplied after the inactive period, this layer causes an initial increased internal resistance of the cell. After a few seconds of use, the electrical current causes the layer to disappear, after which the internal resistance drops down to a normal level. The increased internal resistance results in a voltage drop of the battery when the battery supplies power to a load. This voltage drop is safe and should not cause any disconnection of the battery.

### SUMMARY

One object is to provide a protection circuit that keeps a lithium cell safe, but at the same time does not erroneously disconnect the lithium cell after a period of inactivity.

According to a first aspect, it is provided a protection circuit for protecting a battery comprising a plurality of lithium primary cells. The protection circuit comprises: a switch configured to control when the battery supplies power to a load; and a control circuit being configured to: detect, at a first point in time, when a voltage across at least part of the battery falls below a threshold voltage; and open the switch when the voltage across at least part of the battery remains below the threshold voltage during a preconfigured duration from the first point in time, wherein the opening of the switch is irreversible.

The controller may be configured to open the switch, once the preconfigured duration has passed from the first point in time and when a voltage across the any one of a plurality of lithium primary cells of the battery is below a threshold voltage.

The protection circuit may be connected such that the control circuit can detect voltage separately across each one of the plurality of lithium primary cells when the plurality of lithium primary cells are connected serially.

The preconfigured duration may be between 1 and 20 seconds.

The protection circuit may further comprise a short-circuit protection device, configured to disconnect the battery from the load if a short-circuit occurs.

The protection circuit may further comprise an accelerometer, in which case the control circuit is configured to open the switch when the accelerometer indicates an acceleration magnitude greater than a threshold value.

According to a second aspect, it is provided a battery device comprising a protection circuit according to the first aspect and a plurality of lithium primary cells protected by the protection circuit.

The lithium primary cells may be serially connected.

According to a third aspect, it is provided a method for protecting a battery comprising a plurality of lithium primary cells, the method comprises the steps of: detecting, at a first point in time, when a voltage across at least part of the battery falls below a threshold voltage; and refraining from opening the switch in a preconfigured duration from the first point in time; and opening the switch, once the preconfigured duration has passed from the first point in time and when a the voltage across at least part of the battery is below remains below the a threshold voltage during a preconfigured duration from the first point in time, wherein the opening of the switch is irreversible.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating one embodiment of the invention;

FIG. 2 is a schematic graph illustrating a relationship between time and voltage which is used by the protection circuit of FIG. 1;

FIG. 3 is a flow chart illustrating embodiments of methods for protecting a battery; and

FIG. 4 is a schematic illustration of one embodiment of the control circuit 4 of the protection circuit of FIG. 1.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, it is provided a protection circuit for protecting a battery comprising a plurality of lithium primary cells. The protection circuit is configured to only disconnect the battery when a voltage over at least part of the battery falls below a threshold voltage for a preconfigured duration. After the preconfigured duration, the battery is disconnected if a voltage across any lithium primary cells of the battery is below a threshold voltage. In this way, the protection circuit is active and monitoring the cell voltages after the preconfigured duration to be ready to disconnect if a malfunction is indicated by dropping voltage. At the same time, the protection circuit does not perform any premature and incorrect disconnection of the battery during the preconfigured duration, whereby a perfectly safe and normal initial voltage drop (due to increased internal resistance after a period of inactivity) does not cause the protection circuit to prematurely disconnect the battery.

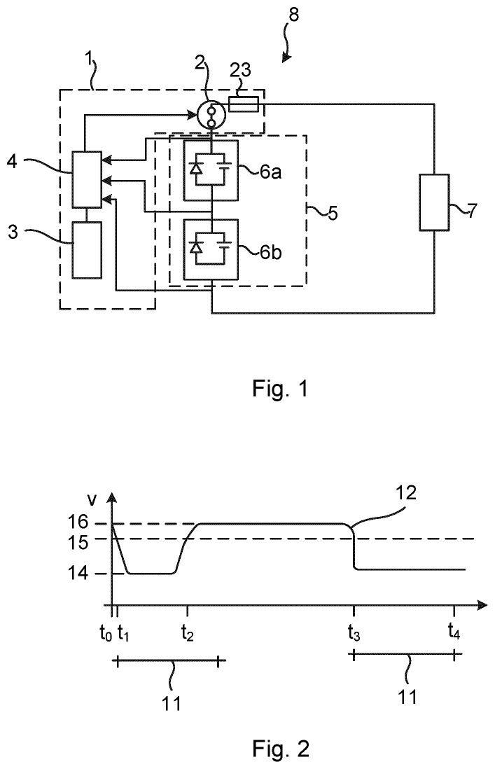

FIG. 1 is a schematic diagram illustrating one embodiment of the invention. A battery 5 comprising a plurality of lithium primary cells 6a, 6b. The battery 5 is thus not rechargeable. Each one of the lithium primary cells 6a, 6b can be of any suitable type, e.g. based on lithium-ion technology or LiSOCl2, LiMnO2, LiFeS2. While the battery 5 is here shown to have two primary lithium cells 6a, 6b, the battery 5 can contain any suitable number of primary lithium cells in series to achieve desired voltage and in parallel to achieve desired charge capacity.

The battery 5 is used to supply power to a load 7. The load 7 can be any suitable electric load which can be powered by the battery 5.

A protection circuit 1 is provided to reduce or eliminate negative effects from the battery 5 by disconnecting the battery from the load when a malfunction is detected. The protection circuit 1 comprises a switch 2 and a control circuit 4. The switch 2 is controllable by the control circuit 4 to disconnect power supply from the battery 5 to the load 7, thereby controlling when the battery 5 supplies power to the load 7. The switch 2 is provided serially between the battery 5 and the load 7.

The switch 2 can be implemented using any suitable technology, including a transistor, a mechanical switch etc, as long as it is controllable by the control circuit 4 to irreversibly open (i.e. to be set in blocking state) on command.

If the voltage of a lithium primary cell is below a critical voltage when supplying power to a load, the cell can be damaged and expand or even explode, which can cause damage to equipment, property and people. This is prevented by the protection circuit 1 as described in more detail with reference to FIG. 2 below.

The protection circuit 1 is connected such that it detects voltage of each one of the lithium primary cells 6a, 6b separately, i.e. the protection circuit monitors voltage over individual primary lithium cells. In this way, a fault in a single one of the lithium primary cells 6a, 6b is more reliably detected and addressed.

Collectively, the battery 5 and the protection circuit 1, which is connected to the battery 5 and thus protects the battery 5, is called a battery device 8. The protection circuit 1 can be soldered to the battery 5. In this case, the protection circuit is provided in a way to make the battery device 8 one cohesive component.

Optionally, the protection circuit 1 also comprises an accelerometer 3 connected to the control circuit. In this case, the control circuit 4 is configured to open the switch 2 when the accelerometer 3 indicates an acceleration magnitude greater than a threshold value. Also this opening can be irreversible. In this way, if the battery device 8 is dropped, e.g. during transport, this results in a positive or negative acceleration (depending on the direction of acceleration sensing), when the battery device 8 hits the floor. The magnitude of the acceleration (i.e. when the negative sign is removed from the negative acceleration) would then be large and the threshold value can be configured such that this is detected, causing the control device 4 to open the switch 2. Optionally, the accelerometer is a three-dimensional accelerometer and the magnitude of acceleration is calculated by combining the vectors of the acceleration in the three dimensions. The magnitude is thus the length of the combined vector. This prevents any damage, to the battery device 8 caused by the drop from propagating or result in secondary damage that might occur if the battery device 8 is connected to power the load 7. When also the opening due to acceleration is irreversible, this prevents a user from reconnecting a potentially faulty battery.

The protection circuit 1 can be implemented using discrete components and/or one or more integrated circuits, e.g. based on an application specific integrated circuit (ASIC), or using a processor, e.g. a microcontroller unit (MCU), digital signal processor (DSP) or other suitable processor, etc. The protection circuit is powered by the lithium primary cells.

Optionally, the protection circuit 1 comprises a short-circuit protection device 23, configured to disconnect the battery 5 from the load 7 if a short-circuit occurs. The short-circuit protection device 23 can be in the form of a fuse. The short-circuit protection device 23 can be provided anywhere in the protection circuit 1 where the battery 5 and the load 7 can be disconnected from each other. The short-circuit protection device 23 can be irreversible after disconnection or it can be resettable.

FIG. 2 is a schematic graph illustrating a relationship between time and voltage which is used by the protection circuit of FIG. 1. The horizontal axis represents time and the vertical axis represents voltage.

A curve represents voltage 12 across a single lithium primary cell, such as any of the lithium primary cells 6a, 6b of FIG. 1, over time.

At an initial point in time t₀, the lithium primary cell starts supplying power to the load after a period of inactivity. From a nominal voltage 16, the voltage drops, at a first point in time t₁, below a threshold voltage 15, to reach a first level 14 and stays there for a period of time. This first level 14 is lower than a nominal level 16 of the lithium primary cell. The nominal level 16 is the voltage that the lithium primary cell reaches when power is supplied and the lithium primary cell is in a normal operative state. The reason for the lower first level 14 of voltage initially is that there is a chemical layer that forms on an exterior surface of the lithium primary cell when it is not in use. When power is again supplied by the lithium primary cell after the inactive period, this layer causes an initial increased internal resistance of the lithium primary cell. When present, this increased internal resistance prevents the voltage of the lithium primary cell to reach its nominal level 16. After a few seconds of use, the electrical current through the layer causes the layer to at least partly disappear, after which the internal resistance drops down to a normal level and the voltage 12 of the lithium primary cell, at time t₂, again rises above the threshold voltage 15, to reach its nominal level 16. The time period from the time t₁ to t₂ is less than a preconfigured duration 11.

At a time t₃ in this example, the unlikely, but possible, event of cell malfunction occurs and the voltage 12 drops. When the voltage 12 drops below the threshold voltage 15, and this is maintained for longer than the preconfigured duration, which here occurs at time t₄, the protection circuit reacts and opens its switch, disconnecting the battery from the load to prevent expansion and/or explosion of the lithium primary cell. For safety reasons, the opening of the switch is configured to be irreversible. This prevents from the switch closing again if the voltage were to return to normal levels which could cause further damage.

The opening of the switch cannot be reversed in any way, neither manually nor electronically. Since the protected battery is a primary cell battery, the situation is resolved by replacing the battery device (comprising the protection circuit and protected battery), a procedure that is common for primary cell batteries, since these types of batteries eventually run out of energy anyway, at which point they need to be replaced. The safety of the protected battery is thus positively ensured. This can be compared with a situation where the opening of the switch is resettable, where a malfunctioning battery could be activated again, which can result in damage to equipment of even personal injuries.

Hence, only if the voltage 12 drops below the threshold voltage 5 for longer than the preconfigured duration 11 the switch 2 is opened. This allows the protection circuit to still react to a low voltage situation (e.g. in time period t₃ to t₄), without incorrectly triggering the switch opening when the internal resistance is temporarily increased initially(e.g. in time period t₁ to t₂).

Since the protection circuit reacts on voltage drops to detect malfunction, protection circuits without the initial inactive period during the preconfigured period 11 would normally react on the low voltage when the chemical layer results in increased internal voltage of the lithium primary cell. This would cause the battery to become inactive already when power starts to be supplied to the load.

In embodiments presented herein, the preconfigured duration 11 is set so that it covers all normal durations of temporary increased internal resistance. On the other hand, the preconfigured duration 11 should not be excessively long since that risks missing a true malfunction at an early stage. In one embodiment, the preconfigured duration 11 is set between 1 and 20 seconds.

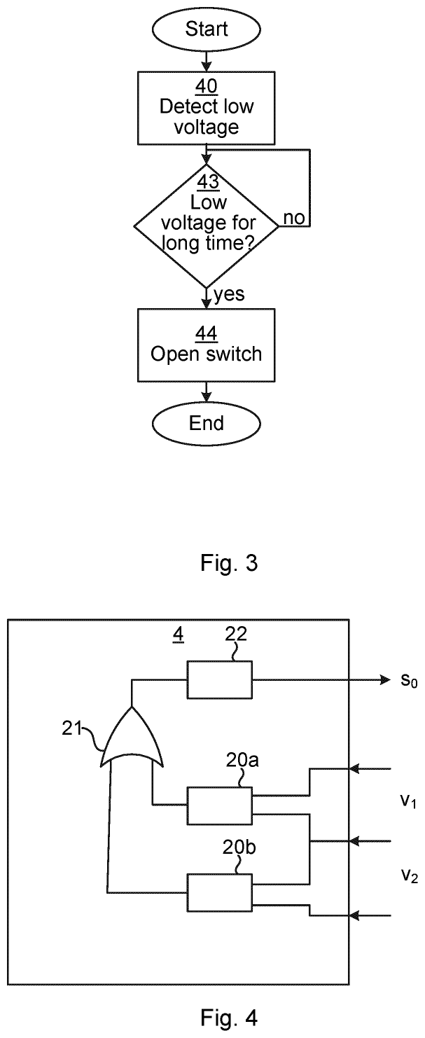

FIG. 3 is a flow chart illustrating embodiments of methods for protecting a battery comprising a plurality of lithium primary cells. The method is performed in the protection circuit.

In a detect low voltage step 40, the protection circuit detects, at a first point in time, when a voltage over at least part of the battery falls below a threshold voltage. For instance, this step can detect when a voltage over lithium primary cell of the battery falls below the threshold voltage. This can comprise detecting a negative flank of the voltage, i.e. the voltage falling from a voltage above the threshold voltage to a voltage below the threshold voltage.

In a conditional low voltage for long timestep 42, the protection circuit determines when the voltage across at least part of the battery (e.g. one of the lithium primary cells) is below the threshold voltage during at least a preconfigured duration from the first point in time. If this is the case, the method proceeds to an open switch step 44. Otherwise, this step is repeated.

In the open switch step 44, the protection circuit opens the switch. When the switch is open, the entire battery, i.e. all cells of the battery, is disconnected from the load.

FIG. 4 is a schematic illustration of one embodiment of the control circuit 4 of the protection circuit of FIG. 1. The actual implementation may vary from FIG. 4; the purpose of this drawings is only an illustratory example.

A first voltage V₁ and a second voltage V₂ are input into the control circuit 4. The first voltage V₁ is the voltage across the first lithium primary cell 6a and the second voltage V₂ is the voltage across the second lithium primary cell 6b.

The first voltage V₁ is provided to a first voltage detector 20a, and the second voltage V₂ is provided to a second voltage detector 20b. Each one of the first and second voltage detectors 20a, 20b are such that they output an active signal when the input voltage is less than a threshold voltage. The active signal can be active low or active high. An inactive signal is the opposite of the active signal, i.e. an inactive high for active low, or an inactive low for active high.

The outputs of the voltage detectors are combined in an OR gate 21, such that the output of the OR gate 21 is active if at least one of the inputs is active.

The output of the OR gate 21 is provided as input to a timing circuit 22. The timing circuit 22 provides the input signal on its output signal, but only after a preconfigured duration 11 from the first point in time t₁. Hence, after the preconfigured duration 11 from the first point in time t₁, an active input to the timing circuit 22 results in an active output and an inactive input to the timing circuit 22 results in an inactive output. Prior to the expiry of the preconfigured duration 11 from the first point in time t₁, the output of the timing circuit 22 is always inactive, regardless of what its input is.

The output of the timing circuit s₀ controls the state of the switch 2, such that an active output s₀ causes the switch to open and an inactive output s₀ causes the switch to close (i.e. be set in a conductive state), or to not change its state. Hence, in this example, an active output from any component is one that contributes to opening the switch and an inactive output from any component is one that does not contribute to opening the switch or that causes the switch to close. The active output can be a high output or low output, depending on the input requirements of the switch. As mentioned above, in one embodiment, once the switch has been opened, it is locked in that state, i.e. the opening of the switch is irreversible.

Here now follows a list of embodiments enumerated with roman numerals.

i. A protection circuit for protecting a battery comprising a plurality of lithium primary cells, the protection circuit comprising: a switch configured to control when the battery supplies power to a load; and a control circuit being configured to: detect, at a first point in time, when a voltage across at least part of the battery falls below a threshold voltage; and open the switch when the voltage across at least part of the battery remains below the threshold voltage during a preconfigured duration from the first point in time.

ii. The protection circuit according to embodiment i, wherein the controller is configured to open the switch, once the preconfigured duration has passed from the first point in time and when a voltage across the any one of a plurality of lithium primary cells of the battery is below a threshold voltage.

iii. The protection circuit according to embodiment ii, wherein protection circuit is connected such that the control circuit can detect voltage separately across each one of the plurality of lithium primary cells when the plurality of lithium primary cells are connected serially.

iv. The protection circuit according to any one of the preceding embodiments, wherein the preconfigured duration is between 1 and 20 seconds.

v. The protection circuit according to any one of the preceding embodiments, further comprising a short-circuit protection device, configured to disconnect the battery from the load if a short-circuit occurs.

vi. A battery device comprising a protection circuit according to any one of the preceding embodiments and a plurality of lithium primary cells protected by the protection circuit.

vii. The battery device according to embodiment vi, wherein the lithium primary cells are serially connected.

viii. A method for protecting a battery comprising a plurality of lithium primary cells, the method comprises the steps of: detecting, at a first point in time, when a voltage across at least part of the battery falls below a threshold voltage; and opening the switch when the voltage across at least part of the battery remains below the threshold voltage during a preconfigured duration from the first point in time.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A protection circuit for protecting a battery comprising a plurality of lithium primary cells, the protection circuit comprising:
a switch configured to control when the battery supplies power to a load; and
a control circuit being configured to:
detect, at a first point in time, when a voltage across at least part of the battery falls below a threshold voltage; and
open the switch when the voltage across at least part of the battery remains below the threshold voltage during a preconfigured duration from the first point in time, wherein the opening of the switch is irreversible.

2. The protection circuit according to claim 1, wherein the controller is configured to open the switch, once the preconfigured duration has passed from the first point in time and when a voltage across the any one of a plurality of lithium primary cells of the battery is below a threshold voltage.

3. The protection circuit according to claim 2, wherein protection circuit is connected such that the control circuit can detect voltage separately across each one of the plurality of lithium primary cells when the plurality of lithium primary cells are connected serially.

4. The protection circuit according to claim 1, wherein the preconfigured duration is between 1 and 20 seconds.

5. The protection circuit according to claim 1, further comprising a short-circuit protection device, configured to disconnect the battery from the load if a short-circuit occurs.

6. The protection circuit according to claim 1, further comprising an accelerometer and wherein the control circuit is configured to open the switch when the accelerometer indicates an acceleration magnitude greater than a threshold value.

7. A battery device comprising a protection circuit according to claim 1, and a plurality of lithium primary cells protected by the protection circuit.

8. The battery device according to claim 7, wherein the lithium primary cells are serially connected.

9. A method for protecting a battery comprising a plurality of lithium primary cells, the method comprising:
detecting, at a first point in time, when a voltage across at least part of the battery falls below a threshold voltage; and
opening the switch when the voltage across at least part of the battery remains below the threshold voltage during a preconfigured duration from the first point in time, wherein the opening of the switch is irreversible.
